(19) United States
(12) Patent Application Publication
(10) Pub. No.: US 2023/0312234 A1
(43) Pub. Date: Oct. 5, 2023

(54) Ventilated Trash Bag Device

(71) Applicant: Mark Key, Zion, IL (US)

(72) Inventor: Mark Key, Zion, IL (US)

(21) Appl. No.: 18/179,469

(22) Filed: Mar. 7, 2023

Related U.S. Application Data
(60) Provisional application No. 63/324,792, filed on Mar. 29, 2022.

(51) Int. Cl. B65F 1/00

(52) U.S. Cl. CPC B65F 1/0026; B65F 2250/1143; B65F 2250/116; B65F 2210/167; B65F 2210/181

(57) ABSTRACT

The present invention relates to a ventilated trash bag device that eliminates excess air within the device when installed within a trash receptacle. The device has at least one ventilation hole and/or ventilation tab that is preferably positioned near an opening of the device. The hole and/or tab allows excess air to leave the body of the device while it is being installed within a trash receptacle.

### CROSS-REFERENCE TO RELATED APPLICATION

The present application claims priority to, and the benefit of, U.S. Provisional Application No. 63/324,792, which was filed on Mar. 29, 2022, and is incorporated herein by reference in its entirety.

### FIELD OF THE INVENTION

The present invention relates generally to the field of trash bags. More specifically, the present invention relates to a ventilated trash bag device with at least one ventilation hole and/or ventilation tab that is preferably positioned near an opening of the device. The hole and/or tab allows excess air to leave the body of the device while it is being installed within a trash receptacle. Accordingly, the present disclosure makes specific reference thereto. Nonetheless, it is to be appreciated that aspects of the present invention are also equally applicable to other like applications, devices, and methods of manufacture.

### BACKGROUND

Installing a trash bag into a trash receptacle can be a frustrating process. More specifically, when a trash bag is placed into a trash receptacle, excess air often inflates the bag. This excess air cannot escape on its own from the bag. As a result, users must manually unseal and reseal the trash bag within the receptacle to maximize the trash bag's capacity.

Therefore, there exists a long-felt need in the art for a device that allows a user to maximize a trash bag's capacity. More specifically, there exists a long-felt need in the art for a ventilated trash bag device that provides an easily installable trash bag. Further, there exists a long-felt need in the art for a ventilated trash bag device that eliminates excess air within the bag while installing the same into a trash receptacle. Further, there exists a long-felt need in the art for a ventilated trash bag device that eliminates the need for a user to manually unseal and reseal a trash bag while installing the trash bag into a trash receptacle.

The subject matter disclosed and claimed herein, in one embodiment thereof, comprises a ventilated trash bag device. The device is primarily comprised of a body having an opening, at least one elastic band, and at least one ventilation tab and/or at least one ventilation hole. The ventilation hole and/or ventilation tab is preferably positioned near the opening. The hole and/or tab allows excess air to leave the body of the device while it is being installed within a trash receptacle. An embodiment of the device with a ventilation tab, may allow the tab to attach back to the body after the device has been positioned within a trash receptacle.

In this manner, the ventilated trash bag device of the present invention accomplishes all the foregoing objectives and provides a ventilated trash bag device that can be easily installed. Further, the device eliminates excess air within the bag while installing the device into a trash receptacle. As a result, the device also eliminates the need for a user to manually unseal and reseal a trash bag while installing the trash bag into a trash receptacle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ventilated trash bag device primarily comprised of a body having an opening, at least one elastic band, and at least one ventilation tab and/or at least one ventilation hole. The body is comprised of a trash bag body that may be any trash bag shape, size, and configuration known in the art. The opening allows a user to insert trash into the body and is preferably comprised of at least one internal band. The band can be pulled from at least one band opening in order to pull the band out from the body, which in turn, closes the opening via shortening the band.

In one embodiment, the body is comprised of at least one ventilation hole. The hole allows air within the body to escape when the device is placed within a trash can or other trash receptacle. This allows a user to easily install the device within a trash can without excess air filling the body during the installation process.

Similarly, in a different embodiment, the body is comprised of at least one ventilation tab that preferably attaches to the outside surface of the body via at least one fastener. In this manner, the tab can be opened to create a tab opening within the body that allows air within the body to escape when trash is placed within the body. This allows a user to easily install the device within a trash can without excess air filling the body during the installation process. Once the bag has been installed within a trash receptacle, the opening can be covered by the tab via the fastener which adheres the tab to the outer surface of the body. This prevents any trash within the body from exiting the body via the opening when the device is removed from a trash receptacle.

Accordingly, the ventilated trash bag device of the present invention is particularly advantageous as it provides an easily installable trash bag that eliminates excess air within the bag while installing the device into a trash receptacle. Further, the device eliminates the need for a user to manually unseal and reseal a trash bag while installing the trash bag into a trash receptacle. In this manner, the ventilated trash bag device overcomes the limitations of existing trash bags and trash bag installation methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a ventilated trash bag device of the present invention in accordance with the disclosed architecture; and

FIG. 2 illustrates a perspective view of one potential embodiment of a ventilated trash bag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to maximize a trash bag's capacity. More specifically, there exists a long-felt need in the art for a ventilated trash bag device that provides an easily installable trash bag. Further, there exists a long-felt need in the art for a ventilated trash bag device that eliminates excess air within the bag while installing the device into a trash receptacle. Further, there exists a long-felt need in the art for a ventilated trash bag device that eliminates the need for a user to manually unseal and reseal a trash bag while installing the trash bag into a trash receptacle.

The present invention, in one exemplary embodiment, is comprised of a ventilated trash bag device primarily comprised of a body having an opening, at least one elastic band, and at least one ventilation tab and/or at least one ventilation hole. The body is comprised of a trash bag body that may be any trash bag shape, size, and configuration known in the art with openings that allow a user to insert trash into the body. The opening is preferably comprised of at least one internal band that can be pulled from at least one band opening in order to pull the band out from the body, which in turn, closes the opening via shortening the band.

In one embodiment, the body is comprised of at least one ventilation hole. The hole allows air within the body to escape when the device is placed within a trash can or other trash receptacle. This allows a user to easily install the device within a trash can without excess air filling the body during the installation process.

In another embodiment, the body is comprised of at least one ventilation tab that preferably attaches to the outside surface of the body via at least one fastener. The tab can be opened to create a tab opening within the body that allows air within the body to escape when trash is placed within the body. This allows a user to easily install the device within a trash can without excess air filling the body during the installation process. Once the bag has been installed within a trash receptacle, the opening can be covered by the tab via the fastener which adheres the tab to the outer surface of the body. This prevents any trash within the body from exiting the body via the opening when the device is removed from a trash receptacle.

Accordingly, the ventilated trash bag device of the present invention is particularly advantageous as it provides an easily installable trash bag that eliminates excess air within the bag while installing the device into a trash receptacle. Further, the device eliminates the need for a user to manually unseal and reseal a trash bag while installing the trash bag into a trash receptacle. In this manner, the ventilated trash bag device overcomes the limitations of existing trash bags and trash bag installation methods known in the art.

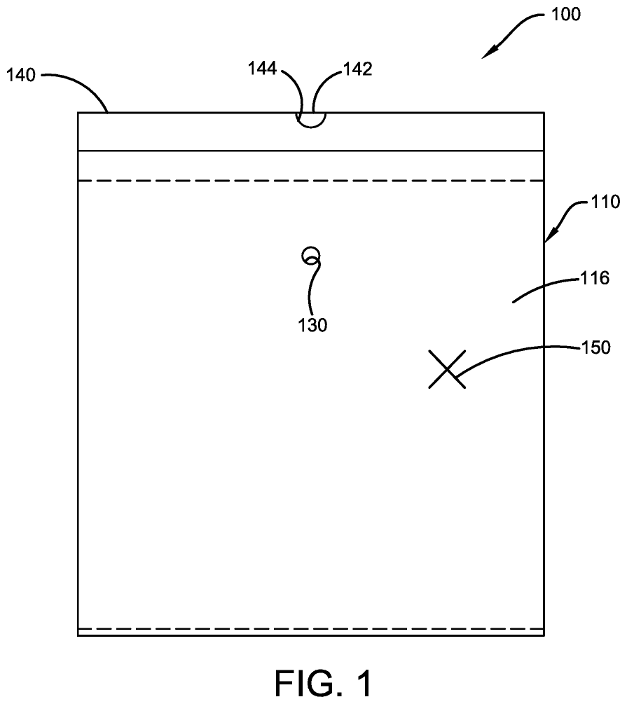

Referring initially to the drawings, FIG. 1 illustrates a perspective view of one potential embodiment of a ventilated trash bag device 100 of the present invention in accordance with the disclosed architecture. The device 100 is comprised of a body 110 having an opening 140, at least one elastic band 142, and at least one ventilation tab 112 and/or at least one ventilation hole 130. The body 110 is comprised of a trash bag body that may be any trash bag shape, size, and configuration known in the art. The body 110 may also be any color known in the art. In one embodiment, the body 110 is infused or coated with at least one fragrance 150. The fragrance 150 may be any smell or fragrance in the art in order to mask the smell of trash within the device 100.

The body 110 is preferably made from a low-density polyethylene material. However, the body 110 may be made from any combination of natural and/or synthetic materials known in the art. In one embodiment, the body 110 is made in whole or in part from a recycled material. The body 110 is also preferably waterproof to prevent trash leakage. In one embodiment, the body 110 is made from a puncture-resistant material that prevents trash within the body 110 from puncturing/ripping the body 110.

The body 110 is also comprised of an opening 140 that allows a user to insert trash into the body 110. In one embodiment, the opening 140 is comprised of at least one internal band 142. The band 142 may be made from the same material as the body 110. In another embodiment, the band 142 is made from an elastic material. The band 142 can be pulled from at least one band opening 144 in order to pull the band 142 out from the body 110, which in turn, closes the opening 140 via shortening the band 142. This allows all trash within the body 110 to be secured within the body 110, and also allows the body 110 to be easily removed from a trash receptacle and carried. In another embodiment, the device 100 is only comprised of an opening 140 and no band 142.

In one embodiment, the body 110 is comprised of at least one ventilation hole 130. The hole 130 is preferably positioned near the opening 140. In different embodiments, a plurality of holes 130 can be arranged in any pattern and number, preferably near the opening 140 to limit the possibility of any spillage from the body 110 via the hole 130. The holes 130 allow air within the body 110 to escape when the device 100 is placed within a trash can or other trash receptacle. This allows a user to easily install the device 100 within a trash can without excess air filling the body 110 during the installation process.

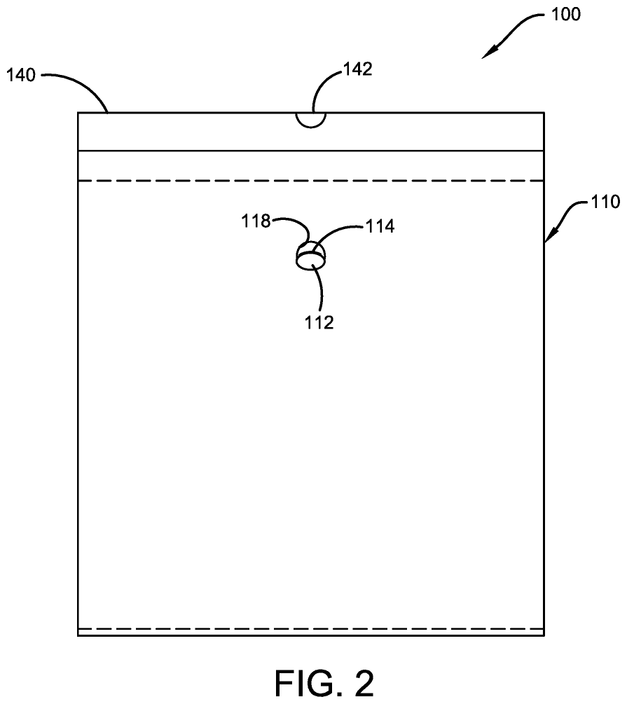

FIG. 2 illustrates a perspective view of one potential embodiment of a ventilated trash bag device 100 of the present invention in accordance with the disclosed architecture. In a different embodiment, the body 110 is comprised of at least one ventilation tab 112. The tab 112 preferably attaches to the outside surface 116 of the body 110 via at least one fastener 114 that is preferably (but not limited to) an adhesive fastener. In this manner, the tab 112 can be opened to create a tab opening 118 within the body 110. The opening 118 allows air within the body 110 to escape when trash is placed within the body 110. This allows a user to easily install the device 100 within a trash can without excess air filling the body 110 during the installation process. In another embodiment, the tab 112 is attached to the body 110 via at least one perforation that allows the tab 112 to be partially torn from the body 110 to form the opening 118.

Once the bag 110 has been installed within a trash receptacle, the opening 118 can be covered by the tab 112 via the fastener 114 which adheres the tab 112 to the outer surface 116 of the body 110. This prevents any trash within the body 110 from exiting the body 110 via the opening 118 when the device 100 is removed from a trash receptacle. The tab 112 is preferably positioned near the opening 140 of the body 110 to limit the possibility of any spillage from the body 110 via the opening 118.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ventilated trash bag device” and “device” are interchangeable and refer to the ventilated trash bag device 100 of the present invention.

Notwithstanding the foregoing, the ventilated trash bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ventilated trash bag device 100 as shown in the FIGS. are for illustrative purposes only, and that many other sizes and shapes of the ventilated trash bag device 100 are well within the scope of the present disclosure. Although the dimensions of the ventilated trash bag device 100 are important design parameters for user convenience, the ventilated trash bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ventilated trash bag device comprising:
a body;
a first opening;
a band positioned around the opening; and
a second opening positioned near the first opening.

2. The ventilated trash bag device of claim 1, wherein the body is comprised of a waterproof material.

3. The ventilated trash bag device of claim 1, wherein the body is comprised of a puncture-resistant material.

4. The ventilated trash bag device of claim 1 further comprised of a band opening positioned on the body.

5. The ventilated trash bag device of claim 1, wherein the body is comprised of a low-density polyethylene material.

6. The ventilated trash bag device of claim 1, wherein the body is comprised of a recycled material.

7. A ventilated trash bag device comprising:
a body;
a first opening;
a band positioned around the first opening and within the body; and
a tab comprised of a fastener.

8. The ventilated trash bag device of claim 7, wherein the tab covers a tab opening on the body.

9. The ventilated trash bag device of claim 7, wherein the fastener is comprised of an adhesive fastener.

10. The ventilated trash bag device of claim 9, wherein the fastener adheres to the body.

11. The ventilated trash bag device of claim 7, wherein the body is comprised of a waterproof material.

12. The ventilated trash bag device of claim 7, wherein the body is comprised of a puncture-resistant material.

13. The ventilated trash bag device of claim 7, wherein the body is comprised of a low-density polyethylene material.

14. The ventilated trash bag device of claim 1, wherein the body is comprised of a recycled material.

15. A ventilated trash bag device comprising:
a body infused with a fragrance;
a first opening;
a band positioned around the first opening and within the body; and
a second opening positioned near the first opening.

16. The ventilated trash bag device of claim 15, wherein the band is comprised of an elastic material.

17. The ventilated trash bag device of claim 15, wherein the body is comprised of a waterproof material.

18. The ventilated trash bag device of claim 15, wherein the body is comprised of a puncture-resistant material.

19. The ventilated trash bag device of claim 15, wherein the body is comprised of a low-density polyethylene material.

20. The ventilated trash bag device of claim 15, wherein the body is comprised of a recycled material.
